(19) United States
(12) Patent Application Publication
(10) Pub. No.: US 2026/0086445 A1
(43) Pub. Date: Mar. 26, 2026

(54) PROJECTION SYSTEM, LIGHT ENGINE MODULE, WAVELENGTH CONVERSION ASSEMBLY THEREOF AND MANUFACTURING METHOD OF WAVELENGTH CONVERSION ASSEMBLY

(71) Applicant: Coretronic Corporation, Hsin-Chu (TW)

(72) Inventor: Kuo-Chou CHANG, Hsin-Chu (TW)

(21) Appl. No.: 19/339,327

(22) Filed: Sep. 25, 2025

(30) Foreign Application Priority Data
Sep. 26, 2024 (CN) 2024113515781

(51) Int. Cl. G03B 21/20; G03B 21/16

(52) U.S. Cl. CPC G03B 21/204; G03B 21/16

(57) ABSTRACT

The invention provides a wavelength conversion assembly, a light engine module, a projection system, and a manufacturing method of the wavelength conversion assembly. The wavelength conversion assembly includes at least two light guiding members and a cladding layer. The cladding layer covers at least a portion of the outer peripheral surface of at least two light guiding members including a first color light guiding member and a second color light guiding member. A first light beam enters the first color light guiding member and the first color light exits the first color light guiding member. A second light beam enters the second color light guiding member and the second color light exits the second color light guiding member. With respect to the first color light and the second color light, the refractive index of the cladding layer is smaller than that of each light guiding member.

### CROSS-REFERENCE TO RELATED APPLICATIONS

This non-provisional application claims priority claim under 35 U.S.C. § 119(a) on China Patent Application No. 202411351578.1 filed Sep. 26, 2024, the entire contents of which are hereby incorporated by reference.

### BACKGROUND OF THE INVENTION

### Field of the Invention

The invention relates to a technical field of a projection system, and more particularly to a projection system, a light engine module, a wavelength conversion assembly and a manufacturing method of the wavelength conversion assembly.

### Description of the Related Art

The information disclosed in this Background section is only for enhancement of understanding of the background of the described technology and therefore may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

Referring to FIG. 1, an optical path structure of a conventional projection system is disclosed. A light beam emitted from a light source LS is guided into a fluorescent color wheel CW1. The fluorescent color wheel CW1 is provided with a plurality of sections including multiple fluorescent sections having fluorescent particles configured to convert a wavelength of light and a transparent section. The fluorescent sections are equipped with reflection layers. A blue light beam LB emitted from the light source LS passes through a beam splitter DM. One of the split blue light beams LB passes through the transparent section of the fluorescent color wheel CW1, and the outgoing light beam remains the blue light beam LB. Another split blue light beam LB travels along an optical path where the blue light beam LB is reflected by a plurality of reflectors RM, and the blue light beam LB passes through the beam splitter DM again and reaches the fluorescent color wheel CW1. In a different time sequence, the blue light beam LB (exciting light beam) enters a fluorescent section to excite the fluorescent particles therein, and an excited light beam is generated, an example being a yellow light beam LY. The yellow light beam LY is reflected by the reflection layers of the fluorescent sections to return to the beam splitter DM and then reflected by the beam splitter DM to enter a filtering color wheel CW2. The filtering color wheel CW2 includes multiple filtering sections or a transparent section. The filtering color wheel CW2 filters light of a predetermined wavelength range of the yellow light beam LY to obtain a red light beam LR or/and a green light beam LG and also allows the blue light beam LB to pass through. Therefore, several color light beams enter an image modulation module IM and a projection lens IL in accordance with a time sequence.

The fluorescent color wheel CW1 has a fluorescent layer disposed on a substrate and a reflection layer disposed between the fluorescent layer and the substrate, or the fluorescent color wheel CW1 has a reflective substrate as the reflection layer. The excited light beam is reflected by the reflection layer to leave the fluorescent color wheel CW1. The conventional light engine module must build a plurality of reflectors and condensing lenses due to reflection of the excited light beam, penetration of the exciting light beam and diffusion of the excited light beam. Moreover, the color wheel must be driven by motors. Therefore, the number of parts is increased, and the motors, the dynamic parts, often occupy a larger space, whereby the construction cost is increased and miniaturization of the projection system is also difficult.

### BRIEF SUMMARY OF THE INVENTION

The invention provides a wavelength conversion assembly, a light engine module, a projection system, and a manufacturing method of the wavelength conversion assembly to solve the problems of construction cost and miniaturization.

Other objectives, features and advantages of the invention will be further understood from the further technological features disclosed by the embodiments of the invention wherein there are shown and described preferred embodiments of this invention, simply by way of illustration of modes best suited to carry out the invention.

To achieve one or a portion or the entirety of the objects or other objects, the wavelength conversion assembly in accordance with an exemplary embodiment of the invention is disposed in an optical path of at least two light beams and includes at least two light guiding members and a cladding layer, wherein the wavelength conversion assembly has an entrance side and an exit side, and each of the light guiding members is an optical channel extending from the entrance side to the exit side and has an outer peripheral surface, an entrance end corresponding to the entrance side and an exit end corresponding to the exit side; wherein the cladding layer covers at least a portion of the peripheral surface of the at least two light guiding members; wherein the at least two light guiding members comprise a first color light guiding member and a second color light guiding member, and the at least two light beams comprise a first light beam and a second light beam; wherein the first light beam is configured to enter the first color light guiding member through the entrance end thereof and propagates therein, and a first color light exits the first color light guiding member through the exit end thereof, wherein a wavelength range of the first light beam is identical to a wavelength range of the first color light; wherein the second light beam is configured to enter the second color light guiding member through the entrance end thereof and propagates therein, and a second color light exits the second color light guiding member through the exit end thereof, wherein a wavelength range of the second color light is different from the wavelength range of the first color light, and a wavelength range of the second light beam is different from or identical to the wavelength range of the first light beam; and wherein, with respect to the first color light and the second color light, the cladding layer has a refractive index smaller than that of each of the at least two light guiding members.

The light engine module in accordance with an exemplary embodiment of the invention configured to provide an illuminating light beam includes a light source assembly providing the at least two light beams and the aforementioned wavelength conversion assembly disposed in the optical paths of the at least two light beams, wherein the illuminating light beam comprises at least one of the first color light and the second color light.

The projection system in accordance with an exemplary embodiment of the invention includes the aforementioned light engine module, an image modulation device disposed in an optical path of the illuminating light beam to convert the illuminating light beam into an image light beam, and a projecting lens disposed in an optical path of the image light beam, wherein the image light beam is projected through the projecting lens to form an image.

The manufacturing method of the wavelength conversion assembly in accordance with an exemplary embodiment of the invention includes the following steps: providing a light guiding material; providing a wavelength conversion material; mixing the wavelength conversion material with the light guiding material and molding the mixture in a mold to form a wavelength conversion rod; providing a cladding material, wherein the cladding material has an optical refractive index smaller than that of the wavelength conversion rod; molding the wavelength conversion rod and the cladding material in a mold such that the cladding material covers an outer peripheral surface of the wavelength conversion rod to form a cladding layer, thereby obtaining a wavelength conversion assembly preform; heating the wavelength conversion assembly preform to a drawing temperature; drawing the heated wavelength conversion assembly preform to form a wavelength conversion wire material; cutting the wavelength conversion wire material to a proper length to form the wavelength conversion assembly.

The wavelength conversion assembly of the invention includes the at least two light guiding members and the cladding layer covering the outer peripheral surface of the light guiding members. The at least two light guiding members include the first color light guiding member and the second color light guiding member. The first light beam enters the first color light guiding member, and the first color light exits therefrom. The first light beam has a wavelength range the same as that of the first color light. The second light beam enters the second color light guiding member, and the second color light exits therefrom. The second light beam has a wavelength range the same as or different from that of the first color light. With respect to the first light beam, the second light beam, the first color light and the second color light, the cladding layer has a refractive index smaller than that of each of the at least two light guiding members, whereby the first light beam and the second light beam are transmitted in the first color light guiding member and the second color light guiding member respectively and also converted into the first color light and the second color light respectively. Thus, the light engine module of the projection system of the invention functions merely through the light source assembly and the wavelength conversion assembly, and the reflectors and motors for dynamic components equipped in the conventional projection system are thus omitted. Therefore, the structure of the projection system is simplified, the construction cost is thus reduced, and miniaturization is also achieved. Moreover, as no dynamic components such as motors are used, the noise of operation is also reduced.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a conventional projection system;

FIG. 2 is a schematic view of a first embodiment of a projection system of the invention;

FIG. 3 is a front view of a wavelength conversion assembly of FIG. 2;

FIG. 4 is a schematic view of another embodiment of a light engine module of the invention;

FIG. 5 is a front view of a wavelength conversion assembly of FIG. 4;

FIG. 6 is a schematic view of a second embodiment of a projection system of the invention;

FIG. 7 is an enlarged view of the portion A of FIG. 6;

FIG. 8 is a schematic view of a third embodiment of a projection system of the invention;

FIG. 9 is an enlarged view of the portion A of FIG. 8;

FIG. 10 is a schematic view of an embodiment of a light engine module of the invention;

FIG. 11 is a schematic view of an embodiment of a light engine module of the invention;

FIG. 12 is a schematic view of an embodiment of a light engine module of the invention;

FIG. 13 is a schematic view of an embodiment of a light engine module of the invention;

FIG. 14 is a schematic view of an embodiment of a light engine module of the invention;

FIG. 15 is a schematic view of an embodiment of a light engine module of the invention;

FIGS. 16, 17 and 18 are schematic views of a manufacturing method of the wavelength conversion assembly of the invention; and

FIG. 19 is a flow chart of the manufacturing method of the wavelength conversion assembly of the invention.

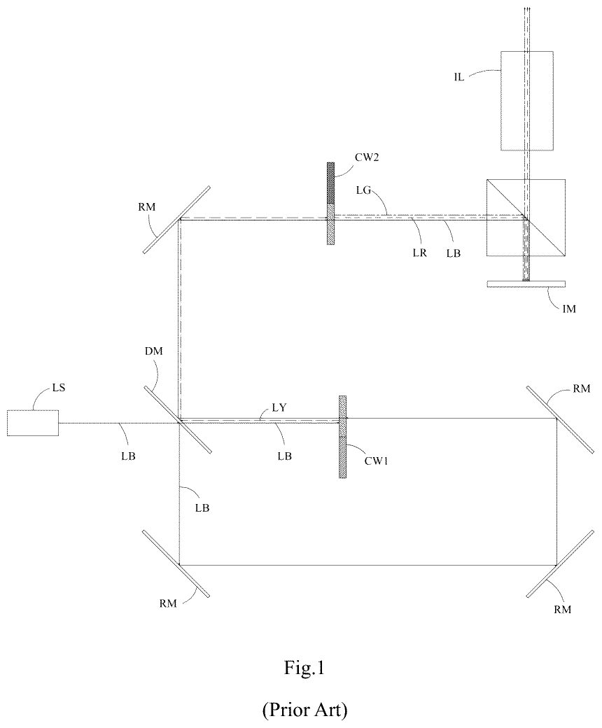

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

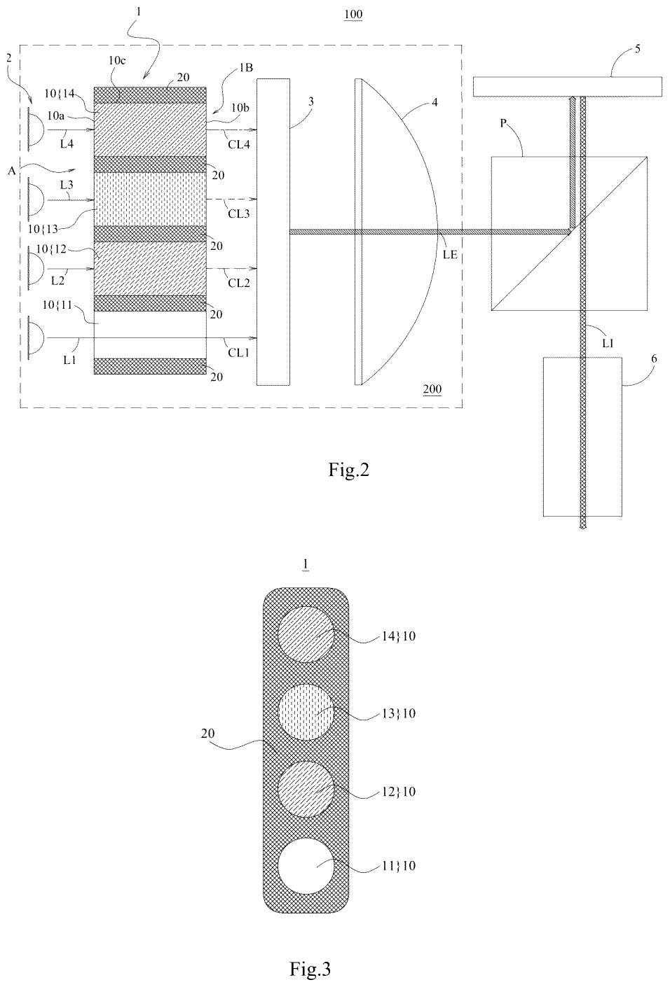

Referring to FIGS. 2 and 3, a projection system 100 of the embodiment includes a light engine module 200, an image modulation device 5 and a projection lens 6, wherein the light engine module 200 is configured to provide an illuminating light beam LE, the image modulation device 5 is disposed in an optical path of the illuminating light beam LE to convert the illuminating light beam LE into an image light beam LI, and the projection lens 6is disposed in an optical path of the image light beam LI to project the image light beam LI to form an image (not illustrated). The light engine module 200 includes a wavelength conversion assembly 1 and a light source assembly 2. The light source assembly 2 includes at least one light emitting member configured to provide at least two light beams containing a first light beam L1 and a second light beam L2. The wavelength conversion assembly 1 is disposed in the optical paths of the light beams. The light emitting member is a light emitting diode, a laser diode or combination of the both. In one embodiment, the projection system 100 further includes a prism P disposed in the optical path of the illuminating light beam LE and the image light beam LI. The prism P guides the image light beam LI to the projection lens 6.

The image modulation module 5 is exemplarily a reflective modulation device, such as a liquid crystal on silicon panel (LCoS panel) or a digital micromirror device (DMD). In other embodiments, the image modulation device 5 is a transparent modulation device, such as a transparent liquid crystal panel, an electro optical modulator, a magneto optic modulator or an acousto-optic modulator (AOM). In this embodiment, the image modulation module 5 is a digital micromirror device (DMD). The projection lens 6 includes exemplarily one optical lens or a combination of multiple optical lenses of different diopters, such as a combination of non-planar lenses, examples being a biconcave lens, biconvex lens, concave-convex lens, convex-concave lens, plane-convex lens and plane-concave lens. In other embodiments, the projection lens 6 further includes planar lenses.

Referring to FIGS. 2 and 3, the wavelength conversion assembly 1 has an entrance side 1A and an exit side 1B. The light beams enter the wavelength conversion assembly 1 through the entrance side 1A and leave the wavelength conversion assembly 1 through the exit side 1B. The wavelength conversion assembly 1 includes at least two light guiding members 10 and a cladding layer 20 covering at least a portion of the outer peripheral surfaces of the light guiding members 10. In another embodiment, the wavelength conversion assembly 1 includes more than two light guiding members 10 arranged in a row along a direction. The cladding layer 20 covers at least a portion of a structure of the outer peripheral surfaces of the light guiding members 10.

In the embodiment, each of the light guiding members 10 is an optical channel constituted by a light guiding material and has an entrance end 10a, an exit end 10b and an outer peripheral surface 10c. The entrance end 10a corresponds to the entrance side 1A, and the exit end 10b corresponds to the exit side 1B. The light beams enter the light guiding member 10 through the entrance end 10a and exit therefrom through the exit end 10b. The cladding layer 20 covers the outer peripheral surface 10c. The light guiding material of the light guiding members 10 is a glass material or a plastic material. Each of the light guiding members 10 has a length-to-diameter ratio in the range of 0.5≤L/D<313, where L represents a length of the light guiding member and D represents a diameter of the light guiding member. The light guiding material is flexible. In one embodiment, each light guiding member 10 has a length L ranging from 10 mm to 250 mm and a diameter D ranging from 0.8 mm to 20 mm.

In one embodiment, the at least two light guiding members 10 include a first color light guiding member 11 and a second color light guiding member 12. The first light beam L1 is adapted to enter the first color light guiding member 11 through the entrance end 10a and is transmitted therein, and a first color light CL1 is emitted from the first color light guiding member 11 through the exit end 10b. The wavelength range of the first light beam L1 is the same as that of the first color light CL1. The second light beam L2 is adapted to enter the second color light guiding member 12 through the entrance end 10a and is transmitted therein. A second color light CL2 is emitted from the second color light guiding member 12 through the exit end 10b. The wavelength range of the second color light CL2 is different from that of the first color light CL1, and the wavelength range of the second light beam L2 is different from or the same as that of the first light beam L1. The cladding layer 20 has a refractive index smaller than that of each of the at least two light guiding members 11, 12 with respect to the first color light CL1 and the second color light CL2. In one embodiment, since the first color light CL1 does not undergo wavelength conversion, the first color light CL1 may be a blue light beam and the second color light CL2 may be a yellow light beam.

In another embodiment, the wavelength conversion assembly 1 includes more than two light guiding members 10, the first color light guiding member 11, the second color light guiding member 12 and a third color light guiding member 13 arranged in a row along a direction. The first light beam L1, the second light beam L2 and the third light beam L3 from the light source assembly 2 enter the first color light guiding member 11, the second color light guiding member 12 and the third color light guiding member 13 respectively through the entrance ends 10a.

In another embodiment, the wavelength conversion assembly 1 includes the first color light guiding member 11, the second color light guiding member 12 and the third color light guiding member 13, and further includes a fourth color light guiding member 14. As shown in FIG. 3, the first color light guiding member 11, the second color light guiding member 12, the third color light guiding member 13 and the fourth color light guiding member 14 are arranged in a row along a direction. The first light beam L1, the second light beam L2, the third light beam L3 and the fourth light beam L4 from the light source assembly 2 enter the first color light guiding member 11, the second color light guiding member 12, the third color light guiding member 13 and the fourth color light guiding member 14 through the entrance ends 10a, respectively.

In the previous embodiments, the second color light guiding member 12 has a first wavelength conversion material, the third color light guiding member 13 has a second wavelength conversion material, and the fourth color light guiding member 14 has a third wavelength conversion material. The first color light guiding member 11 is not provided with a wavelength conversion material. The first wavelength conversion material, the second wavelength conversion material and the third wavelength conversion material all include a plurality of fluorescent particles. When the fluorescent particles are irradiated by the light beam, the molecules of the fluorescent particles are energized to an excited state. The light beam is, for example, a laser. When the molecules of the fluorescent particles return to a steady state, an excited light beam (ΔE=hν) is emitted. The excited light beam has a wavelength range different from that of the light beam (exciting light beam); thus, the wavelength range is converted. Therefore, the second light beam L2, the third light beam L3 and the fourth light beam L4 enter the second color light guiding member 12, the third color light guiding member 13 and the fourth color light guiding member 14 respectively as the excitation light beams to excite the first wavelength conversion material, the second wavelength conversion material and the third wavelength conversion material, respectively, whereby the second color light CL2, the third color light CL3 and the fourth color light CL4 are generated and emitted from the second color light guiding member 12, the third color light guiding member 13 and the fourth color light guiding member 14 respectively. The first light beam L1 enters the first color light guiding member 11 and the first color light CL1 exits therefrom. As the first color light guiding member 11 is not provided with a wavelength conversion material, the first color light CL1 has the same wavelength range as that of the first light beam L1; that is, the first color light guiding member 11 has no beam wavelength conversion effect. The second color light CL2 has a wavelength range different from that of the second light beam L2, the third color light CL3 has a wavelength range different from that of the third light beam L3, and the fourth color light CL4 has a wavelength range different from that of the fourth light beam L4.

In the embodiment, the first light beam L1, the second light beam L2, the third light beam L3 and the fourth light beam L4 have the same wavelength range; for example, they are all blue light beams (lasers). Since the first color light CL1 has not undergone wavelength convertation, the first color light CL1 remains a blue light beam. The second color light CL2 is a yellow light beam converted from the second light beam L2 by the first wavelength conversion material. The third color light CL3 is a red light beam converted from the third light beam L3 by the second wavelength conversion material. The fourth color light CL4 is a green light beam converted from the fourth light beam L4 by the third wavelength conversion material.

The first color light CL1, the second color light CL2, the third color light CL3 and the fourth color light CL4 pass through a light combination assembly 3 and a light condensing assembly 4 to form the illuminating light beam LE exiting the light engine module 200; that is, the illuminating light beam LE includes at least one of the first color light CL1, the second color light CL2, the third color light CL3 and the fourth color light CL4. The illuminating light beam LE is guided by the prism P to enter the image modulation device 5 where the illuminating light beam LE is converted into the image light beam LI.

As mentioned above, the cladding layer 20 covers at least a portion of the outer peripheral surface 10c of at least two light guiding members 10 or at least a portion of the outer peripheral surface 10c of the plurality of light guiding members 10, and the cladding layer 20 extends on the outer peripheral surface 10c to be flush with the light input end 10a and the light output end 10b. The cladding layer 20 is made of glass or plastic, and the refractive index of the cladding layer 20 is smaller than that of each light guiding member 10 with respect to the first light beam L1, the second light beam L2, the third light beam L3, the fourth light beam L4, the first color light CL1, the second color light CL2, the third color light CL3 and the fourth color light CL4. The light guiding member 10 is an optically denser medium with respect to light, whereas the cladding layer 20 is an optically thinner medium with respect to light. When the light beam travels from the optically denser medium to the optically thinner medium, total reflection will occur at the interface of the light guiding member 10 and the cladding layer 20. Therefore, the first light beam L1, the second light beam L2, the third light beam L3, the fourth light beam L4, the first color light CL1, the second color light CL2, the third color light CL3 and the fourth color light CL4 can be transmitted in the respective light guiding members 10 along the axial directions thereof such that a plurality of total reflections occur at the interfaces of the corresponding light guiding members 10 and the cladding layer 20.

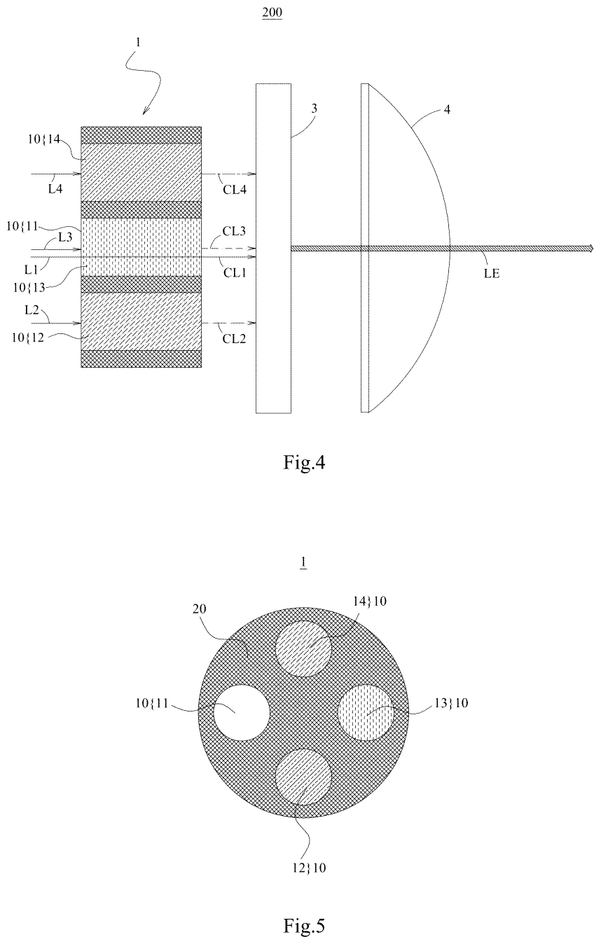

Referring to FIGS. 4 and 5, another embodiment of the light engine is disclosed. The embodiment has a portion of a structure identical to the first embodiment, and therefore the identical components are represented by identical symbols and their descriptions are thus omitted. The difference between this embodiment and the first embodiment is that the plurality of light guiding members 10 of the wavelength conversion assembly 1 of this embodiment are arranged in an M×N array. The four light guiding members 10 of this embodiment are arranged in a 2×2 array. The cladding layer 20 covers the four light guiding members 10, whereby the wavelength conversion assembly 1 forms a cylindrical structure.

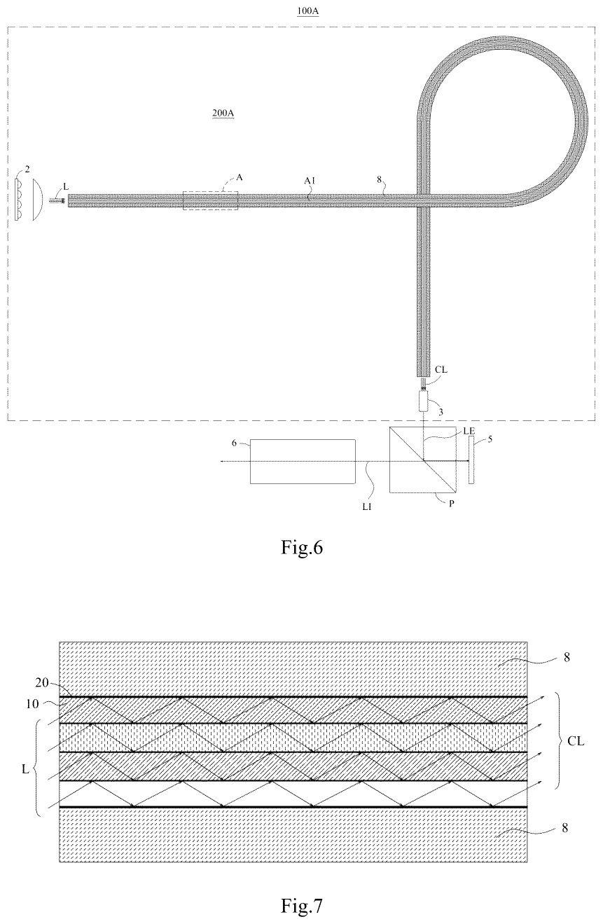

Referring to FIG. 6 and FIG. 7, the projection system 100A of this embodiment includes a light engine module 200A, an image modulation device 5, and a projection lens 6. The light engine module 200A includes a wavelength conversion assembly A1, a light source assembly 2, a light combination assembly 3, and a light condensing assembly 4. The wavelength conversion assembly A1 of this embodiment is substantially the same as the wavelength conversion assembly 1 of the aforementioned embodiments. The wavelength conversion assembly A1 includes a plurality of light guiding members 10, and a cladding layer 20 covers the outer peripheral surface of the light guiding members 10. The wavelength conversion assembly A1 is flexible, and therefore the optical path structure of the projection system 100A can be arranged in a bending manner. In another embodiment, the projection system 100A includes a prism P. The arrangement and function of the prism P are the same as those of the aforementioned embodiments and will not be described again. At least one of the light guiding members 10 of the wavelength conversion assembly A1 of this embodiment is provided with a wavelength conversion material 30 (for example, fluorescent particles). As shown in FIG. 7, the wavelength conversion material 30 of the embodiment is uniformly distributed in the light guiding material of the light guiding member 10, and the cladding layer 20 is not provided with the wavelength conversion material 30. When the light beam L enters the light guiding member 10 through the entrance end 10a from the light source component 2, as, with respect to the light beam L, the refractive index of the light guiding member 10 is greater than the refractive index of the cladding layer 20, several total reflections of the light beam L occur at the interface of the light guiding member 10 and the cladding layer 20, whereby the light beam L is transmitted along the axial direction of the light guiding member 10. At the same time, the light beam L excites the wavelength conversion material 30 to generate a color light CL. With respect to the color light CL, the refractive index of the light guiding member 10 is greater than the refractive index of the cladding layer 20. Therefore, the color light CL is also transmitted along the axial direction of the light guiding member 10 in the manner of total reflections at the interface and emitted from the light guiding member 10 through the exit end 10b. A plurality of color lights CL pass through the light combination assembly 3 to form the illuminating light beam LE; that is, the illuminating light beam LE includes at least one of the color lights CL. The illuminating light beam LE is guided by the prism P to enter the image modulation device 5, where an image light beam LI is formed. The image light beam LI enters the projection lens 6 to be projected onto a screen to form an image. The light beam L can be at least one of the first light beam L1, the second light beam L2, the third light beam L3 and the fourth light beam L4 in the aforementioned embodiments, and the color light CL can be at least one of the first color light CL1, the second color light CL2, the third color light CL3 and the fourth color light CL4 in the aforementioned embodiments.

The light engine module 200A of the embodiment further includes a heat dissipation member 8 contacting at least a portion of the cladding layer 20 of the wavelength conversion assembly A1 and corresponding to the light guiding member 10 having a wavelength conversion material. As the wavelength conversion material is excited to emit a light beam (i.e., color light), heat is generated in the light guiding member 10 having the wavelength conversion material and causes the temperature thereof to rise. Therefore, the heat dissipation member 8 can dissipate the heat generated by the light guiding member 10. In other embodiments, the heat dissipation member 8 can also dissipate heat by airflow over the surface of the heat dissipation member 8 in a heat convection manner, or by cooling liquid flowing inside the heat dissipation member 8 in a heat exchange manner. FIG. 6 shows that the heat dissipation member 8 contacts the entire cladding layer 20 of the wavelength conversion assembly A1, but in other embodiments, the heat dissipation member 8 can also contact only a portion of the cladding layer 20 corresponding to the arrangement position of the wavelength conversion material.

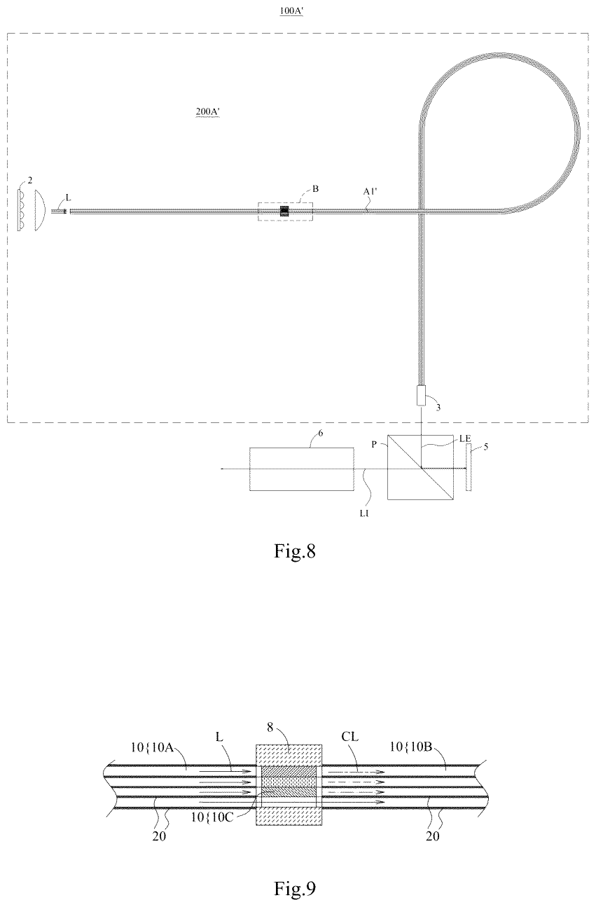

Please refer to FIG. 8 and FIG. 9. The embodiment has a portion of a structure identical to the second embodiment in FIG. 6, and therefore the identical components are represented by identical symbols and their descriptions are thus omitted. The difference between the embodiment and the second embodiment is that the wavelength conversion material 30 is only disposed in a portion of the structure of the light guiding member 10 of the wavelength conversion assembly A1′ of the embodiment. FIG. 9 is a partial cross-sectional view of the wavelength conversion assembly A1′. The light guiding member 10 shown in FIG. 8 includes a first transmission section 10A, a second transmission section 10B, and a wavelength conversion section 10C only where a wavelength conversion material is disposed. FIG. 9 shows a portion of the first transmission section 10A and the second transmission section 10B. The first transmission section 10A and the second transmission section 10B are respectively connected to opposite sides of the wavelength conversion section 10C by insertion fitting or bonding, but the embodiment is not limited thereto. The light beam L is transmitted in the first transmission section 10A of the light guiding member 10 in the axial direction by total reflection and enters the wavelength conversion section 10C. The light beam excites the wavelength conversion material in the wavelength conversion section 10C to generate the color light CL. The color light CL enters the second transmission section 10B and is transmitted in the second transmission section 10B along the axial direction by total reflection. The color light CL finally enters the light combining component 3 after it leaves the light guiding member 10 through the exit end. The heat dissipation member 8 of the embodiment is only disposed in the portion of the cladding layer 20 corresponding to the wavelength conversion section 10C.

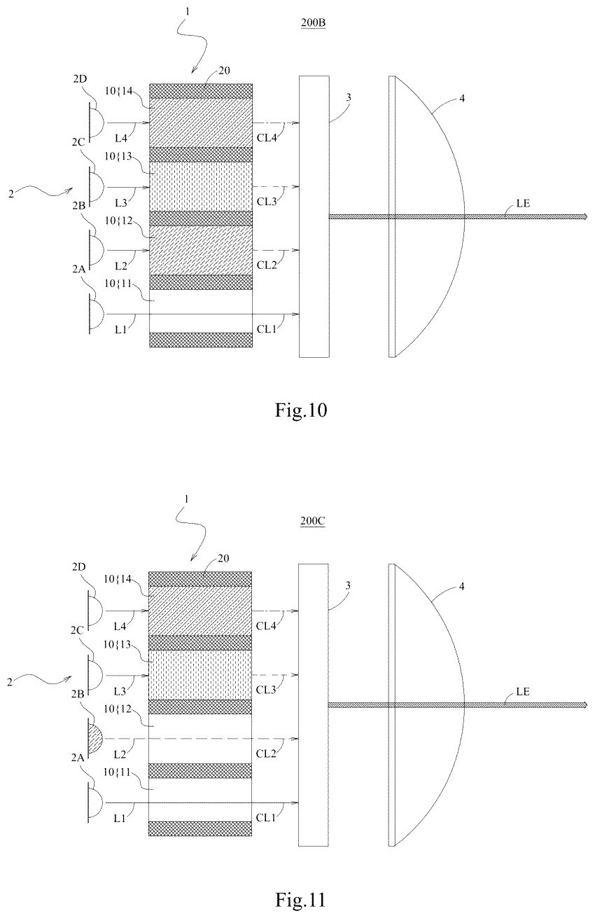

Referring to FIG. 10, the light engine module 200B of the embodiment includes a wavelength conversion assembly as in the aforementioned embodiments. The light engine module 200B of the embodiment also includes a light source assembly 2, a light combination assembly 3, and a light condensing assembly 4. Similar to the wavelength conversion assembly 1 shown in FIG. 2, the wavelength conversion assembly 1 shown in FIG. 10 includes a plurality of light guiding members 10 and a cladding layer 20 covering the outer peripheral surface of the light guiding member 10. The plurality of light guiding members 10 include a first color light guiding member 11, a second color light guiding member 12, a third color light guiding member 13 and a fourth color light guiding member 14. No wavelength conversion material is provided in the first color light guiding member 11. The second color light guiding member 12 is provided with a first wavelength conversion material uniformly distributed therein. The third color light guiding member 13 is provided with a second wavelength conversion material uniformly distributed therein. The fourth color light guiding member 14 is provided with a third wavelength conversion material uniformly distributed therein. The light source assembly 2 in this embodiment includes a first light emitting member 2A, a second light emitting member 2B, a third light emitting member 2C and a fourth light emitting member 2D. In this embodiment, the first light emitting member 2A emits a first light beam L1, the second light source 2B emits a second light beam L2, the third light source 2C emits a third light beam L3, and the fourth light source 2D emits a fourth light beam L4. In one embodiment, each light emitting member may be, for example, a light emitting chip. In another embodiment, each light-emitting member may, for example, include one or more light-emitting chips and/or microlenses forming a modalized component through a packaging process. The same modalized light emitting member may be configured with chips that provide light beams of the same color or different colors.

The first light beam L1, the second light beam L2, the third light beam L3 and the fourth light beam L4 of the embodiment have an identical wavelength range; for example, they are all blue light beams. The first light beam L1 generates the first color light CL1 after passing through the first color light guiding member 11. As the first color light guiding member 11 is not provided with a wavelength conversion material, the wavelength range of the first color light CL1 is the same as that of the first light beam L1; for example, the first color light CL1 is a blue light beam. The second light beam L2 is converted into the second color light CL2 after passing through the second color light guiding member 12 provided with a first wavelength conversion material. The second light beam L2 is an excitation light beam, and the second color light CL2 is an excited light beam. Therefore, the second color light CL2, for example, a yellow light beam, has a wavelength range different from that of the second light beam L2, the blue light beam. The third light beam L3 is converted into a third color light CL3 after passing through the third color light guiding member 13 provided with a second wavelength conversion material. The third light beam L3 is an excitation light beam, and the third color light CL3 is an excited light beam. Therefore, the third color light CL3, for example, a red light beam, has a wavelength range different from that of the third light beam L3, the blue light beam. The fourth light beam L4 is converted into a fourth color light CL4 after passing through the fourth color light guiding member 14 provided with a third wavelength conversion material. The fourth light beam L4 is an excitation light beam, and the fourth color light CL4 is an excited light beam. Therefore, the fourth color light CL4, for example, a green light beam, has a wavelength range different from that of the fourth light beam L4, the blue light beam.

The first color light CL1, the second color light CL2, the third color light CL3 and the fourth color light CL4 emitted from the respective corresponding light guiding members 10 pass through the light combination assembly 3 for light combination. The combined light beam converges through the condensing assembly 4 to form the illumination light beam LE including, for example, at least one of the first color light CL1, the second color light CL2, the third color light CL3 and the fourth color light CL4.

Referring to FIG. 11, the light engine module 200C of this embodiment has a portion of a structure identical to the light engine module 200B shown in FIG. 10, and therefore the identical components are represented by identical symbols and their descriptions are thus omitted. The difference between the embodiment and the embodiment in FIG. 10 is that the first color light guiding member 11 and the second color light guiding member 12 of the embodiment are provided with no wavelength conversion materials, the third color light guiding member 13 is provided with a second wavelength conversion material, and the fourth color light guiding member 14 is provided with a third wavelength conversion material. The first light emitting member 2A emits a first light beam L1, the second light emitting member 2B emits a second light beam L2, the third light emitting member 2C emits a third light beam L3, and the fourth light emitting member 2D emits a fourth light beam L4. The first light beam L1, the third light beam L3 and the fourth light beam L4 have the same wavelength range; for example, they are blue light beams. The second light beam L2 has a wavelength range different from those of the first light beam L1, the third light beam L3 and the fourth light beam L4. The second light beam L2 is, for example, a yellow light beam; that is, the second light beam L2 provided by the second light emitting member 2B remains unconverted, is transmitted in the second light guiding member 12, and is emitted as a second color light CL2 having the same wavelength range as that of the second light beam L2. The wavelength range of the first color light CL1, for example, a blue light beam, is the same as that of the first light beam L1. The wavelength range of the second color light CL2, for example, a yellow light beam, is the same as that of the second light beam L2. As the third color light CL3 is an excited light beam, the wavelength range of the third color light CL3, for example, a red light beam, is different from that of the third light beam L3, the blue light beam. As the fourth color light CL4 is an excited light beam, the wavelength range of the fourth color light CL4, for example, a green light beam, is different from that of the fourth light beam L4.

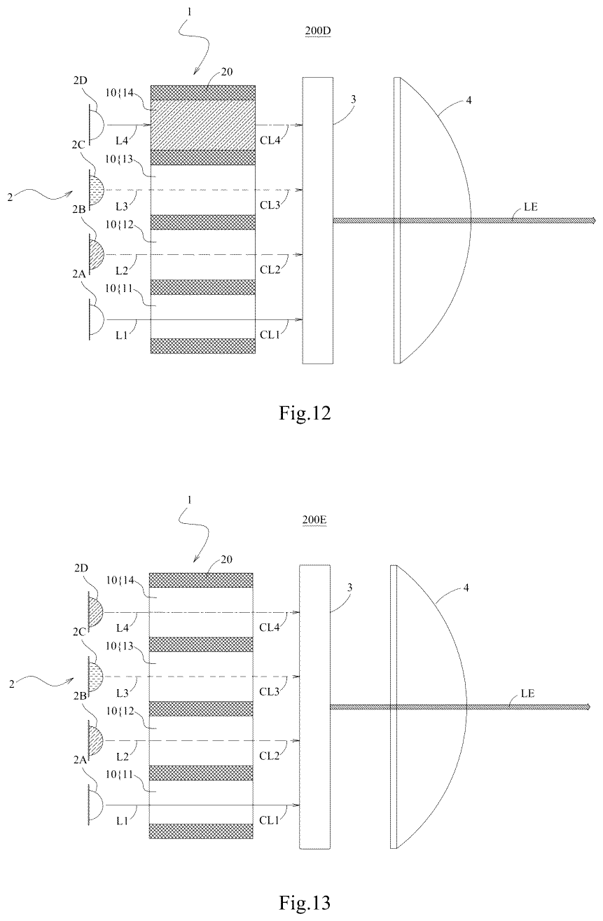

Referring to FIG. 12, the light engine module 200D of the embodiment has a portion of a structure identical to the light engine module 200C shown in FIG. 11, and therefore the identical components are represented by identical symbols and their descriptions are thus omitted. The difference between the embodiment and the embodiment shown in FIG. 11 is that the first color light guiding member 11, the second color light guiding member 12 and the third color light guiding member 13 of the embodiment are provided with no wavelength conversion materials, and the fourth color light guiding member 14 is provided with a third wavelength conversion material. The first light emitting member 2A emits a first light beam L1, the second light emitting member 2B emits a second light beam L2, the third light emitting member 2C emits a third light beam L3, and the fourth light emitting member 2D emits a fourth light beam L4. The first light beam L1 and the fourth light beam L4 have the same wavelength range, for example, a blue light beam, and the second light beam L2, for example, a yellow light beam, has a different wavelength range from that of the first light beam L1 and the fourth light beam L4. The third light beam L3, for example, a red light beam, has a different wavelength range from those of the first light beam L1, the second light beam L2 and the fourth light beam L4. The wavelength range of the first color light CL1 is the same as that of the first light beam L1, which is, for example, a blue light beam. The wavelength range of the second color light CL2 is the same as that of the second light beam L2, which is, for example, a yellow light beam. The wavelength range of the third color light CL3 is the same as that of the third light beam L3, which is, for example, a red light beam. As the fourth color light CL4 is an excited light beam, the wavelength range of the fourth color light CL4, for example, a green light beam, is different from that of the fourth light beam L4, the blue light beam.

Referring to FIG. 13, the light engine module 200E of the embodiment has a portion of a structure identical to the light engine module 200D shown in FIG. 12, and therefore the identical components are represented by identical symbols and their descriptions are thus omitted. The difference between the embodiment and the embodiment shown in FIG. 12 is that the first color light guiding member 11, the second color light guiding member 12, the third color light guiding member 13, and the fourth color light guiding member 14 are all provided with no wavelength conversion materials. The first light emitting member 2A emits a first light beam L1, the second light emitting member 2B emits a second light beam L2, the third light emitting member 2C emits a third light beam L3, and the fourth light emitting member 2D emits a fourth light beam L4. The wavelength ranges of the first light beam L1, the second light beam L2, the third light beam L3, and the fourth light beam L4 are all different from one another. For example, the first light beam L1 is a blue light beam, the second light beam L2 is a yellow light beam, the third light beam L3 is a red light beam, and the fourth light beam L4 is a green light beam. The wavelength range of the first color light CL1, for example, a blue light beam, is the same as that of the first light beam L1, the blue light beam. The wavelength range of the second color light CL2, for example, a yellow light beam, is the same as that of the second light beam L2, the yellow light beam. The wavelength range of the third color light CL3, for example, a red light beam, is the same as that of the third light beam L3, the red light beam. The wavelength range of the fourth color light CL4, for example, a green light beam, is the same as that of the fourth light beam L4, the green light beam.

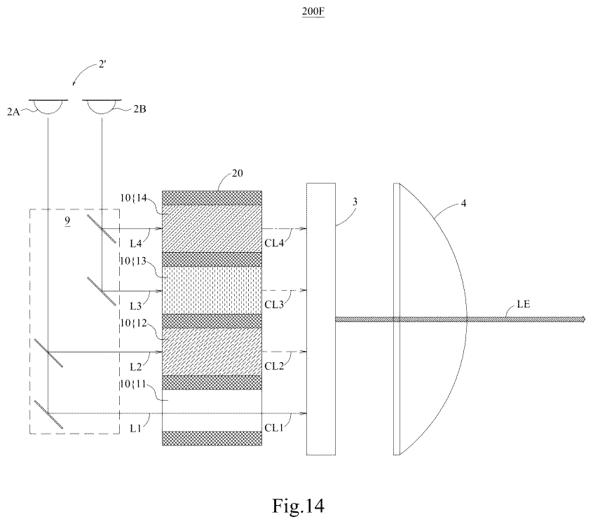

Referring to FIG. 14, the light engine module 200F of the embodiment has a portion of a structure identical to the light engine module 200B shown in FIG. 10, and therefore the identical components are represented by identical symbols and their descriptions are thus omitted. The difference between the embodiment and the embodiment shown in FIG. 10 is that the light engine module 200F of the embodiment further includes a light splitting assembly 9, and the light source assembly 2′ of the embodiment includes a first light emitting member 2A and a second light emitting member 2B. The light beam emitted by the first light emitting member 2A is split into a first light beam L1 and a second light beam L2 by a portion of the optical components in the light splitting assembly 9. The first light beam L1 and the second light beam L2 have the same wavelength range; for example, both are blue light beams. The light beam emitted by the second light emitting member 2B is split into a third light beam L3 and a fourth light beam L4 by another portion of the optical components in the light splitting assembly 9. The third light beam L3 and the fourth light beam L4 have the same wavelength range; for example, both are blue light beams. In more detail, the light splitting assembly 9 includes, for example, first to fourth optical components (not numbered), the light beam emitted by the first light emitting member 2A first passes through the first optical component (for example, a beam splitter or a semi-transmissive half-reflecting mirror), a portion of the light beam penetrates the first optical component and is reflected by the second optical component to form a first light beam L1, and another part of the light beam is reflected by the first optical component (for example, a reflector) to form the second light beam L2. The light beam emitted by the second light emitting member 2B first passes through the third optical component (for example, a beam splitter or a semi-transmissive half-reflecting mirror), a portion of the light beam penetrates the third optical component and is reflected by the fourth optical component to form the third light beam L3, and another portion of the light beam is reflected by the third optical component (for example, a reflector) to form the fourth light beam L4.

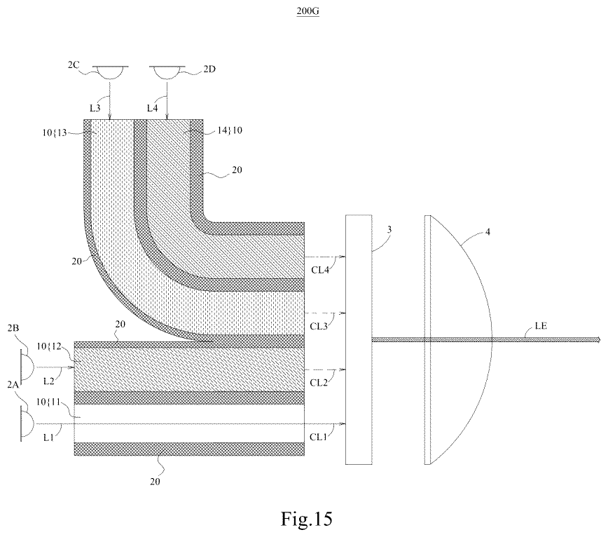

Referring to FIG. 15, the light engine module 200G of the embodiment has a portion of a structure identical to the light engine module 200B shown in FIG. 10, and therefore the identical components are represented by identical symbols and their descriptions are thus omitted. The difference between the embodiment and the embodiment shown in FIG. 10 is that the third color light guiding member 13 and the fourth color light guiding member 14 of the embodiment are disposed in a bending manner, wherein the third color light guiding member 13 and the fourth color light guiding member 14 have sections close to the entrance end extending along a direction different from that of the first color light guiding member 11 and the second color light guiding member 12, whereas the sections of the third color light guiding member 13 and the fourth color light guiding member 14 have other sections close to the exit end extending along a direction the same as that of the first color light guiding member 11 and the second color light guiding member 12. The positions of the third light emitting member 2C and the fourth light emitting member 2D are arranged corresponding to the third color light guiding member 13 and the fourth color light guiding member 14. In more detail, the first light emitting member 2A and the second light emitting member 2B are in a perpendicular arrangement relative to the third light emitting member 2C and the fourth light emitting member 2D.

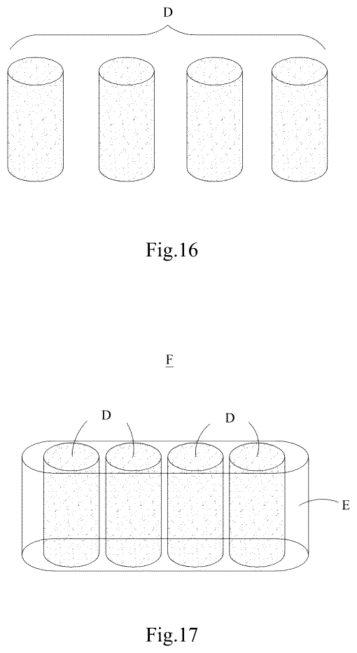

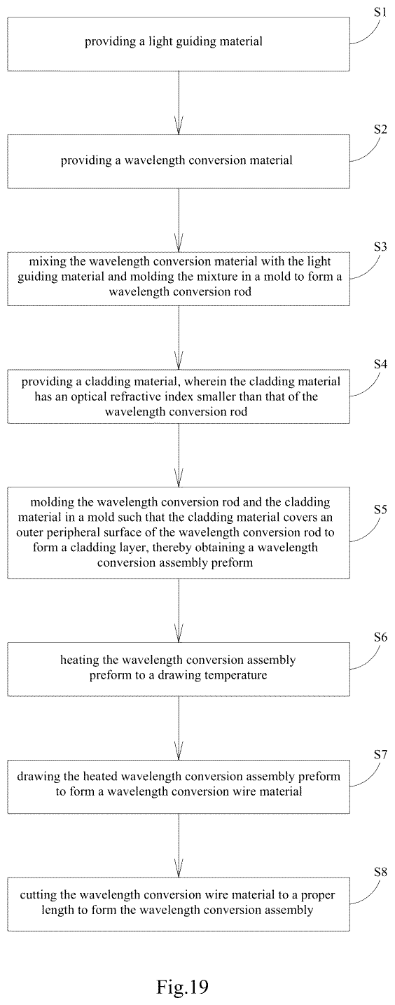

Referring to FIGS. 16, 17, 18 and 19, a manufacturing method of the wavelength conversion assembly is disclosed.

In step S1, a light guiding material is provided, and the light-guiding material is, for example, glass or plastic. Then the procedure enters step S2.

In step S2, a wavelength conversion material is provided, and the wavelength conversion material includes fluorescent particles. Then the procedure enters step S3.

In step S3, the wavelength conversion material is mixed with the light guiding material and molded in a mold to form a wavelength conversion rod D, as shown in FIG. 16. Then the procedure enters step S4.

In step S4, a cladding material is provided, and the cladding material has a refractive index smaller than that of the wavelength conversion rod D. Then the procedure enters step S5.

In step S5, the wavelength conversion rod D and the cladding material are molded in a mold such that the cladding material covers the outer peripheral surface of the wavelength conversion rod to form a cladding layer E, thereby obtaining a wavelength conversion assembly preform F, as shown in FIG. 17. Then the procedure enters step S6.

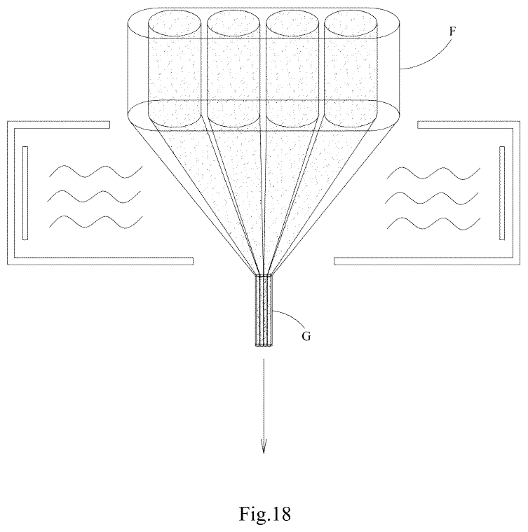

In step S6, the wavelength conversion assembly preform F is heated to the drawing temperature, as shown in FIG. 18. Then the procedure enters step S7.

In step S7, the heated wavelength conversion assembly preform F is drawn to obtain a wavelength conversion wire material G. Then the procedure enters step S8.

In step S8, the wavelength conversion wire material G is cut to a proper length to form a wavelength conversion assembly 1.

The softening temperature of the wavelength conversion material is higher than the softening temperature of the cladding material, and the drawing temperature is higher than the softening temperature of the wavelength conversion material and lower than the crystallization temperature of the wavelength conversion material. Therefore, the wavelength conversion material and the cladding material will soften at the same time to facilitate drawing, and crystallization of the wavelength conversion material can be avoided, which would affect the characteristics of light beam transmission.

The wavelength conversion assembly of the invention includes the at least two light guiding members and the cladding layer covering the outer peripheral surface of the light guiding members. The at least two light guiding members include a first color light guiding member and a second color light guiding member. The first light beam enters the first color light guiding member, and the first color light exits therefrom. The first light beam has a wavelength range the same as that of the first color light. The second light beam enters the second color light guiding member, and the second color light exits therefrom. The second light beam has a wavelength range the same as or different from that of the first color light. With respect to the first light beam, the second light beam, the first color light and the second color light, the cladding layer has a refractive index smaller than that of each of the at least two light guiding members with respect to the first light beam, the second light beam, the first color light and the second color light, whereby the first light beam and the second light beam are transmitted in the first color light guiding member and the second color light guiding member respectively and also converted into the first color light and the second color light respectively. Thus, the light engine module of the projection system of the invention functions merely through the light source assembly and the wavelength conversion assembly, and the reflectors and motors for dynamic components equipped in the conventional projection system are thus omitted. Therefore, the structure of the projection system is simplified, the construction cost is thus reduced, the miniaturization is also achieved. Moreover, as no dynamic components such as motors are used, the noise of operation is also reduced.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode of practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may use the terms “first”, “second”, etc. to refer to a noun or member. Such terms should be understood as a nomenclature and should not be construed as giving the limitation on the number of the members modified by such nomenclature unless a specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no member or component in the disclosure is intended to be dedicated to the public regardless of whether the member or component is explicitly recited in the following claims.

What is claimed is:

1. A wavelength conversion assembly disposed in an optical path of at least two light beams, the wavelength conversion assembly having an entrance side and an exit side, and comprising: at least two light guiding members and a cladding layer;
wherein each of the at least two light guiding members is an optical channel made of a light-guiding material, extending from the entrance side to the exit side and has an outer peripheral surface, an entrance end corresponding to the entrance side and an exit end corresponding to the exit side;
wherein the cladding layer covers at least a portion of the outer peripheral surface of the at least two light guiding members;
wherein the at least two light guiding members comprise a first color light guiding member and a second color light guiding member, and the at least two light beams comprise a first light beam and a second light beam;
wherein the first light beam is configured to enter the first color light guiding member through the entrance end thereof and propagates therein, and a first color light exits the first color light guiding member through the exit end thereof, wherein a wavelength range of the first light beam is identical to a wavelength range of the first color light;
wherein the second light beam is configured to enter the second color light guiding member through the entrance end thereof and propagates therein, and a second color light exits the second color light guiding member through the exit end thereof, wherein a wavelength range of the second color light is different from the wavelength range of the first color light, and a wavelength range of the second light beam is different from or identical to the wavelength range of the first light beam; and
wherein, with respect to the first color light and the second color light, the cladding layer has a refractive index smaller than that of each of the at least two light guiding members.

2. The wavelength conversion assembly as claimed in claim 1, wherein each of the light guiding members has a length-to-diameter ratio in the range of 0.5≤L/D<313, and the wavelength conversion assembly is flexible.

3. The wavelength conversion assembly as claimed in claim 1, wherein the entrance end and the exit end are located at two opposite ends of each of the light guiding members, the entrance end and the exit end are connected to the outer peripheral surface, and the entrance end and the exit end are exposed from the cladding layer.

4. The wavelength conversion assembly as claimed in claim 3, wherein the cladding layer extends on the outer peripheral surface to be flush with the entrance end and the exit end.

5. The wavelength conversion assembly as claimed in claim 1, wherein the light guiding material is glass or plastic, the cladding layer is made of glass or plastic, and the wavelength conversion assembly is flexible.

6. The wavelength conversion assembly as claimed in claim 1, wherein the second light beam has a wavelength range different from that of the first light beam and identical to that of the second color light, or the second light beam has a wavelength range identical to that of the first light beam, and a first wavelength conversion material configured to convert the wavelength range of the second light beam into the wavelength range of the second color light is disposed in at least a portion of the second color light guiding member.

7. The wavelength conversion assembly as claimed in claim 6, wherein the first wavelength conversion material is uniformly distributed in the light guiding material of the second color light guiding member.

8. The wavelength conversion assembly as claimed in claim 6, wherein the at least two light guiding members further comprise a third color light guiding member, the at least two light beams further comprise a third light beam configured to enter the third color light guiding member through the entrance end and propagating therein, a third color light exits the third color light guiding member through the exit end, a wavelength range of the third color light is different from the wavelength range of the first color light and the wavelength range of the second color light, and a wavelength range of the third light beam is different from or identical to the wavelength range of the first light beam.

9. The wavelength conversion assembly as claimed in claim 8, wherein the wavelength range of the third light beam is different from the wavelength range of the first light beam and identical to the wavelength range of the third color light, or the wavelength range of the third light beam is identical to the wavelength range of the first light beam, and a second wavelength conversion material configured to convert the wavelength range of the third light beam into the wavelength range of the third color light is disposed in at least a portion of the third color light guiding member.

10. The wavelength conversion assembly as claimed in claim 8, wherein the second wavelength conversion material is uniformly distributed in the light guiding material of the third color light guiding member.

11. The wavelength conversion assembly as claimed in claim 8, wherein the at least two light guiding members further comprise a fourth color light guiding member, the at least two light beams further comprise a fourth light beam configured to enter the fourth color light guiding member through the entrance end and propagating therein, a fourth color light exits the fourth color light guiding member through the exit end, a wavelength range of the fourth color light is different from the wavelength range of the first color light, the wavelength range of the second color light and the wavelength range of the third color light, and the wavelength range of the fourth light beam is different from or identical to the wavelength range of the first light beam.

12. The wavelength conversion assembly as claimed in claim 11, wherein the wavelength range of the fourth light beam is different from the wavelength range of the first light beam and identical to the wavelength range of the fourth color light, or the wavelength range of the fourth light beam is identical to the wavelength range of the first light beam and a third wavelength conversion material configured to convert the wavelength range of the fourth light beam into the wavelength range of the fourth color light is disposed in at least a portion of the fourth color light guiding member.

13. The wavelength conversion assembly as claimed in claim 11, wherein the third wavelength conversion material is uniformly distributed in the light guiding material of the fourth color light guiding member.

14. The wavelength conversion assembly as claimed in claim 11, wherein, with respect to the third color light and the fourth color light, the cladding layer has a refractive index smaller than that of each of the at least two light guiding members.

15. The wavelength conversion assembly as claimed in claim 1, wherein the at least two light guiding members are arranged in a row or a matrix and the cladding layer covers the outer peripheral surfaces of the at least two light guiding members to form an integrated structure.

16. The wavelength conversion assembly as claimed in claim 5, wherein at least one of the light guiding members has an extension direction different from that of another of the light guiding members.

17. A light engine module configured to provide an illuminating light beam, comprising:
a light source assembly configured to provide at least two light beams; and
a wavelength conversion assembly disposed in an optical path of the at least two light beams, the wavelength conversion assembly having an entrance side and an exit side, and comprising: at least two light guiding members and a cladding layer;
wherein each of the at least two light guiding members is an optical channel made of a light-guiding material, extending from the entrance side to the exit side and has an outer peripheral surface, an entrance end corresponding to the entrance side and an exit end corresponding to the exit side;
wherein the cladding layer covers at least a portion of the outer peripheral surface of the at least two light guiding members;
wherein the at least two light guiding members comprise a first color light guiding member and a second color light guiding member, and the at least two light beams comprise a first light beam and a second light beam;
wherein the first light beam is configured to enter the first color light guiding member through the entrance end thereof and propagates therein, and a first color light exits the first color light guiding member through the exit end thereof, wherein a wavelength range of the first light beam is identical to a wavelength range of the first color light;
wherein the second light beam is configured to enter the second color light guiding member through the entrance end thereof and propagates therein, and a second color light exits the second color light guiding member through the exit end thereof, wherein a wavelength range of the second color light is different from the wavelength range of the first color light, and a wavelength range of the second light beam is different from or identical to the wavelength range of the first light beam; and
wherein, with respect to the first color light and the second color light, the cladding layer has a refractive index smaller than that of each of the at least two light guiding members,
wherein the illuminating light beam comprises at least one of the first color light and the second color light.

18. The light engine module as claimed in claim 17, further comprising a light splitting assembly, wherein the light source assembly comprises at least one first light emitting member configured to provide a light beam split by the light splitting assembly into the first light beam and the second light beam, and the wavelength range of the second light beam is identical to the wavelength range of the first light beam.

19. The light engine module as claimed in claim 17, wherein the light source assembly comprises at least one first light emitting member configured to provide a first light beam and at least one second light emitting member configured to provide a second light beam, and the wavelength range of the second light beam is different from or identical to the wavelength range of the first light beam.

20. The light engine module as claimed in claim 19, wherein the at least two light guiding members further comprise a third color light guiding member, the at least two light beams further comprise a third light beam configured to enter the third color light guiding member through the entrance end and propagating therein, a third color light exits the third color light guiding member through the exit end, wherein the light source assembly further comprises at least one third light emitting member configured to provide the third light beam, a wavelength range of the third light beam is different from or identical to the wavelength range of the first light beam, and the illuminating light beam comprises at least one of the first color light, the second color light and the third color light.

21. The light engine module as claimed in claim 20, wherein the at least two light guiding members further comprise a fourth color light guiding member, the at least two light beams further comprise a fourth light beam configured to enter the fourth color light guiding member through the entrance end and propagating therein, a fourth color light exits the fourth color light guiding member through the exit end, wherein the light source assembly further comprises at least one fourth light emitting member configured to provide the fourth light beam, a wavelength range of the fourth light beam is different from or identical to the wavelength range of the first light beam, and the illuminating light beam comprises at least one of the first color light, the second color light, the third color light and the fourth color light.

22. The light engine module as claimed in claim 17, further comprising a light combination assembly, wherein all of the exit ends of the at least two light guiding members are coupled to the light combination assembly.

23. The light engine module as claimed in claim 17, further comprising a heat dissipation member contacting at least a portion of the cladding layer and disposed corresponding to at least one of the light guiding members.

24. The light engine module as claimed in claim 23, wherein gas flows over a surface of the heat dissipation member for heat dissipation by convection, or cooling liquid flows in the heat dissipation member for heat dissipation by heat exchange.

25. A projection system, comprising:
a light engine module configured to provide an illuminating light beam, comprising:
a light source assembly configured to provide at least two light beams; and
a wavelength conversion assembly disposed in an optical path of the at least two light beams, the wavelength conversion assembly having an entrance side and an exit side, and comprising: at least two light guiding members and a cladding layer;
wherein each of the at least two light guiding members is an optical channel made of a light-guiding material, extending from the entrance side to the exit side and has an outer peripheral surface, an entrance end corresponding to the entrance side and an exit end corresponding to the exit side;
wherein the cladding layer covers at least a portion of the outer peripheral surface of the at least two light guiding members;
wherein the at least two light guiding members comprise a first color light guiding member and a second color light guiding member, and the at least two light beams comprise a first light beam and a second light beam;
wherein the first light beam is configured to enter the first color light guiding member through the entrance end thereof and propagates therein, and a first color light exits the first color light guiding member through the exit end thereof, wherein a wavelength range of the first light beam is identical to a wavelength range of the first color light;
wherein the second light beam is configured to enter the second color light guiding member through the entrance end thereof and propagates therein, and a second color light exits the second color light guiding member through the exit end thereof, wherein a wavelength range of the second color light is different from the wavelength range of the first color light, and a wavelength range of the second light beam is different from or identical to the wavelength range of the first light beam; and
wherein, with respect to the first color light and the second color light, the cladding layer has a refractive index smaller than that of each of the at least two light guiding members,
wherein the illuminating light beam comprises at least one of the first color light and the second color light;
an image modulation device disposed in an optical path of the illuminating light beam to convert the illuminating light beam into an image light beam;
a projecting lens disposed in an optical path of the image light beam, wherein the image light beam is projected through the projecting lens to form an image.

26. A manufacturing method of a wavelength conversion assembly, comprising:
providing a light guiding material;
providing a wavelength conversion material;
mixing the wavelength conversion material with the light guiding material and molding the mixture in a mold to form a wavelength conversion rod;
providing a cladding material, wherein the cladding material has an optical refractive index smaller than that of the wavelength conversion rod;
molding the wavelength conversion rod and the cladding material in a mold such that the cladding material covers an outer peripheral surface of the wavelength conversion rod to form a cladding layer, thereby obtaining a wavelength conversion assembly preform;
heating the wavelength conversion assembly preform to a drawing temperature;
drawing the heated wavelength conversion assembly preform to form a wavelength conversion wire material;
cutting the wavelength conversion wire material to a proper length to form the wavelength conversion assembly.

27. The manufacturing method as claimed in claim 26, wherein a softening temperature of the wavelength conversion material is higher than that of the cladding material, and the drawing temperature is higher than the softening temperature of the wavelength conversion material and lower than a crystallization temperature of the wavelength conversion material.
